(19) United States
(12) Patent Application Publication
(10) Pub. No.: US 2026/0331843 A1
(43) Pub. Date: Oct. 22, 2026

(54) ELECTRICAL OUTLET EXTENDER FOR A DOOR AND METHOD OF INSTALLATION

(71) Applicant: AMRIS Consulting, LLC, Bradenton, FL (US)

(72) Inventor: Christopher Slipcheck, Bradenton, FL (US)

(73) Assignee: AMRIS Consulting, LLC, Bradenton, FL (US)

(21) Appl. No.: 19/654,198

(22) Filed: Apr. 21, 2026

Related U.S. Application Data
(60) Provisional application No. 63/791,761, filed on Apr. 21, 2025.

(51) Int. Cl. H01R 13/74; H01R 13/447

(52) U.S. Cl. CPC H01R 13/74; H01R 13/447

(57) ABSTRACT

An electrical outlet extender for a door that includes a first housing body with a rear surface coupled to a door rear surface and with a first housing sidewall defining a first cavity housing a male electrically conductive plug configuration coupled to electrical wiring. The extender also includes a shaft of a substantially rigid material coupled to the rear surface of the first housing body, defining a channel with the electrical wiring disposed therein, and interposed within a door and spanning the door thickness. The extender also includes a second housing body coupled to the shaft and the door front surface, a second housing sidewall defining a second cavity housing an electrically conductive female socket configuration electrically coupled to the male electrically conductive plug configuration through the electrical wiring, and defining an electrical socket port providing access to the female electrically conductive socket configuration.

### FIELD OF THE INVENTION

The present invention relates generally to electrical outlet extension assemblies and, more particularly, relates to electrical outlet extensions for door or wall-like structure and the installation thereof.

### BACKGROUND OF THE INVENTION

Electrical outlets are widely known. Electrical outlets function as fixed points for distributing electrical power, enabling the safe connection and operation of appliances and devices. These outlets are typically installed within walls and are strategically placed to accommodate the needs of residential, commercial, and industrial environments. However, situations often arise where outlets are not conveniently located, prompting the use of electrical outlet extenders. Outlet extenders, also referred to as extension assemblies, are devices designed to facilitate access to electrical power in locations distant from the original source. They generally comprise a flexible conduit, such as a cord, and a plurality of additional outlets or charging ports, thus extending the serviceable area for power delivery.

Despite their utility, conventional electrical outlet extenders are beset by notable limitations, particularly when used to supply electricity to rooms lacking readily accessible wall outlets. The prevalent method involves routing an extension cord or similar device beneath or alongside a door to transfer power from a room equipped with outlets to a space without such access. This practice introduces several practical impediments. Foremost among these is the inability of the door to close fully, a condition that compromises both energy efficiency and security. In applications such as extending power into a garage, the partially open door may lead to the loss of conditioned air, adversely affecting heating and cooling performance. Moreover, gaps created by the cord serve as entry points for insects and other pests, diminishing the comfort and safety of the home environment.

In addition, prior art extenders often create trip hazards and can be damaged by repeated mechanical stress from the opening and closing of doors. Over time, this wear can lead to fraying or breakage of the cord’s insulation, presenting potential electrical hazards such as shocks or fire risks. Another disadvantage relates to the aesthetics and organization of living spaces, i.e., cords left exposed or tangled detract from the appearance of a room and can create clutter that complicates cleaning or furniture placement.

Furthermore, conventional extenders may not meet certain building codes or electrical safety standards, particularly when used in a manner that alters the intended operation of doors or passageways. Improper installation or use can also result in electrical overloads—especially if multiple high-power devices are connected—thus increasing the likelihood of circuit failure or even electrical fires.

These shortcomings underscore a critical need for improved electrical outlet extenders that can safely and effectively provide power across doorways or similar barriers, without inhibiting door function or compromising the structural and environmental integrity of the building. Solutions that address these deficiencies could significantly enhance convenience, safety, and operational efficiency in both residential and commercial settings. Therefore, a need exists to overcome the problems with the prior art as discussed above.

### SUMMARY OF THE INVENTION

The invention provides an electrical outlet extender for a door that overcomes the hereinafore-mentioned disadvantages of the heretofore-known devices and methods of this general type and that.

With the foregoing and other objects in view, there is provided, in accordance with the invention, an electrical outlet extender for a door operably coupled to a door frame, having a door front surface, a door rear surface opposing a front door surface, and a door thickness separating the door front and rear surfaces. The assembly also includes a first housing body with a rear surface coupled to the door rear surface and with a first housing sidewall surrounding the rear surface defining a first cavity housing a male electrically conductive plug configuration coupled to electrical wiring. Additionally, the assembly includes a shaft of a substantially rigid material coupled to the rear surface of the first housing body, defining a channel with the electrical wiring disposed therein, and interposed within a door and spanning the door thickness. Additionally, the second housing body includes a rear surface coupled to the shaft and the door front surface, with a second housing sidewall surrounding the rear surface of the second housing body, defining a second cavity housing an electrically conductive female socket configuration electrically coupled to the male electrically conductive plug configuration through the electrical wiring, and defining an electrical socket port providing access to the female electrically conductive socket configuration.

In accordance with a further feature of the present invention, the rear surface of the first housing sidewall is directly coupled to the door rear surface in a flush configuration.

In accordance with another feature, an embodiment of the present invention also includes an elastomeric material disposed on the rear surface of the first housing body and an elastomeric material disposed on the rear surface of the second housing body.

In accordance with yet another feature, an embodiment of the present invention also includes the shaft having an inner surface defining the channel and an outer surface opposing the inner surface of the shaft and having a threaded configuration thereon and selectively removably coupled to the second housing body.

In accordance with a further feature of the present invention, the threaded configuration is an over molded polymeric material directly coupled to the electrical wiring.

In accordance with an additional feature of the present invention, a cap may be selectively removably coupled to the first housing body in a friction fit configuration, covering the first cavity, and including a tether member coupling the cap to the first housing body when the cap is selectively removed from the first housing body.

In accordance with a further feature of the present invention, a cap may be selectively removably coupled to the second housing body in a friction fit configuration, covering the electrical socket port.

In accordance with a further feature of the present invention, the rear surface of the first housing body is coupled to the shaft in a transversely overlapping configuration and the rear surface of the second housing body is coupled to the shaft in a transversely overlapping configuration.

In accordance with an exemplary feature of the present invention, the first housing body and the second housing body are coupled to one another through the shaft in a longitudinally aligned and overlapping configuration.

In accordance with a further feature of the present invention, the first housing body and the second housing body are disposed proximal to a lower edge of the door.

In accordance with a further feature of the present invention, the first housing body is formed in a substantially perpendicular orientation relative to an orientation of the shaft and including the first cavity and the male electrically conductive plug configuration configured to face in a direction substantially parallel to a plane defined by the door rear surface.

In accordance with an additional feature of the present invention, the first housing body is operably configured to rotate relative to the shaft.

In accordance with present invention, a method of installing an electrical outlet extender on a door has been disclosed that includes providing a first housing body with a rear surface, with a first housing sidewall surrounding the rear surface defining a first cavity housing a male electrically conductive plug configuration coupled to electrical wiring, and with a shaft of a substantially rigid material coupled to the rear surface of the first housing body, and defining a channel with the electrical wiring disposed therein and a second housing body with a rear surface, with a second housing sidewall surrounding the rear surface of the second housing body, defining a second cavity housing an electrically conductive female socket configuration, and defining an electrical socket port providing access to the electrically conductive female socket configuration. Other steps include forming a door channel completely through a door having a door rear surface and a door front surface opposing the door rear surface of the door, inserting the shaft through the door channel until the rear surface of the first housing body is flush with the door rear surface, coupling the second housing body with the shaft until the rear surface of the second housing body is flush with the door front surface, and electrically coupling the electrical wiring with the electrically conductive female socket configuration.

In accordance with yet another feature, an embodiment of the present invention also includes inserting an electrical plug of an extension cord electrically charged from an electrical outlet of a housing structure into the electrical socket port and electrically coupling the electrical plug to the electrically conductive female socket configuration and the male electrically conductive plug configuration.

In accordance with yet another feature, an embodiment of the present invention also includes providing a first cap and a second cap and coupling the first cap to the first housing body in a friction fit configuration and covering the first cavity and coupling the second cap to the second housing body in a friction fit configuration, covering the electrical socket port.

Although the invention is illustrated and described herein as embodied in an electrical outlet extender for a door or wall-like structure, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not necessarily drawn to scale but, where applicable, may be utilized to support a particular structural configuration or geometric relationship between components utilized in the assembly.

Before the present invention is disclosed and described, it is to be understood that the terminology used herein is for the purpose of describing particular embodiments only and is not intended to be limiting. The terms “a” or “an,” as used herein, are defined as one or more than one, wherein the utilization of “a” or “an” does not mean multiple structures with various functions may be utilized to equate to single claimed structure with claimed functionality. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user’s perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the extender or in a direction through a door-like structure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational front view of an electrical outlet extender for a door in accordance with one embodiment of the present invention;

FIG. 2 is a close-up elevational front view of the electrical outlet extender in FIG. 1;

FIG. 3 is an elevational side view of the door in FIG. 1;

FIG. 4 is an elevational rear view of the door in FIG. 1;

FIG. 5 is a close-up elevational rear view of the electrical outlet extender in FIG. 1;

FIGS. 6-8 are views of the electrical outlet extender in FIG. 1 with a cross-sectional door;

FIG. 9 is an exploded view of a second housing body on the electrical outlet extender in accordance with one embodiment of the present invention;

FIG. 10 is a partially exploded view of a first housing body on the electrical outlet extender in accordance with one embodiment of the present invention;

FIG. 11 is an exploded view of the electrical outlet extender for a door in accordance with one embodiment of the present invention;

FIG. 12 is an exploded view of an electrical outlet extender for a door in accordance with another embodiment of the present invention; and

FIG. 13 is a process flow diagram depicting a method of installing an electrical outlet extender for a door.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

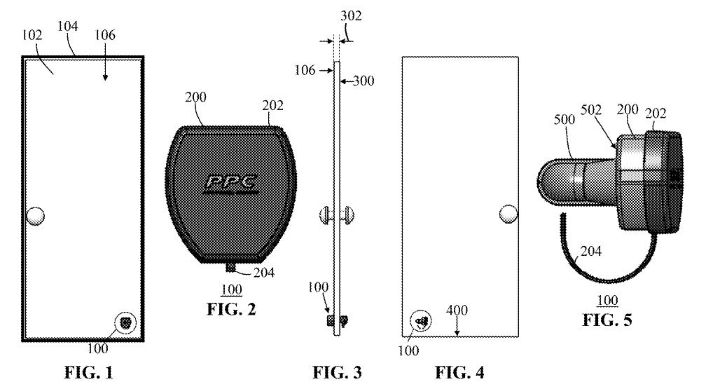

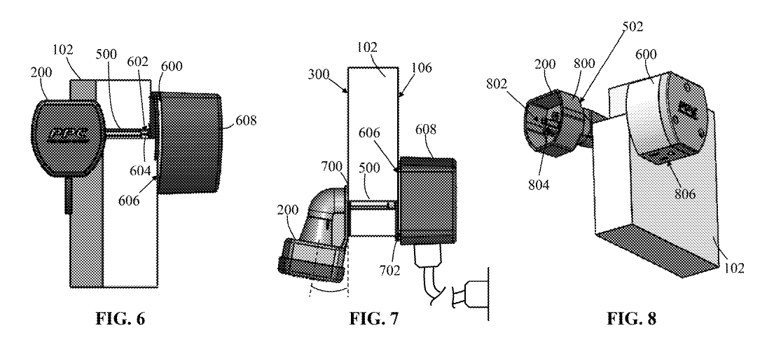

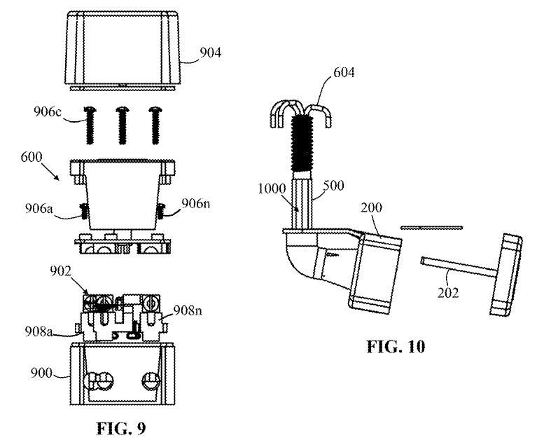

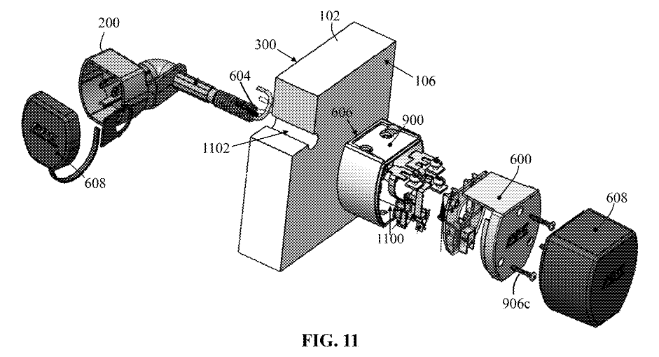

The present invention provides an electrical outlet extender for a door that effectively, safely, and efficiently enables users to provide electrical outlets to a room through a door structure. Referring now to FIG. 1, one embodiment of the present invention is shown in a perspective view. FIG. 1 shows several advantageous features of the present invention, but, as will be described below, the invention can be provided in several shapes, sizes, combinations of features and components, and varying numbers and functions of the components. The first example of an electrical outlet extender 100 for a door 102, as shown in FIGS. 1-11, includes a first housing body 200 housing an electrically conductive plug configuration 804, a shaft 500 housing electrical wiring (e.g., a single or multiple wires/cable/shaft), and a second housing body 600 housing an electrically conductive female socket configuration 902.

In particular, the first housing body 200 includes a rear surface 502 that may be substantially planar and is preferably selectively couplable to the door rear surface 300 and with a first housing sidewall 800 surrounding the rear surface 502. As used herein, the term “wall” is intended broadly to encompass continuous structures, as well as, separate structures that are coupled together so as to form a substantially continuous external surface. The first housing sidewall 800 defines (partially) a first cavity 802 housing a male electrically conductive plug configuration 804 coupled to the electrical wiring 604 (e.g., copy wire, NM-B, Cat5e, Cat6, neutral/ground/live) that is then electrically coupled to the metallic prong(s) of the electrically conductive female configuration 902. The shaft 500 is coupled to the rear surface 502 of the first housing body 200 and is preferably of a substantially rigid material (e.g., thermoplastic polyurethane, flexible PVC, etc.) that can support the weight of the housing bodies 200, 600 coupled thereto without material or plastic deformation. The shaft 500 defines a channel 600 with the electrical wiring disposed therein and interposed within a door 102 and spanning the door thickness 302 when installed.

The second housing body 600 includes a rear surface 606 selectively removably coupled to the shaft 500 and the door front surface 106 when installed. The second housing body 600 includes a second housing sidewall 900 surrounding the rear surface 606 of the second housing body 600 and that defines a second cavity 1100 housing an electrically conductive female socket configuration 902 electrically coupled to the male electrically conductive plug configuration 804 through the electrical wiring 604. The second housing body 600 also defines an electrical socket port 806 providing access to the electrically conductive female socket configuration 902, i.e., for an electrical plug of an extension cord to be inserted therein (schematically illustrated in FIG. 7, albeit with the cover 608 removed).

The shaft 106 may be integrally coupled to one of the housing bodies 200, 600 and selectively removably coupled to an opposing body or selectively removably coupled and couplable to both bodies 200, 600. Exemplary materials utilized for components in the assembly should be substantially rigid, except where increased flexibility or elasticity is desired.

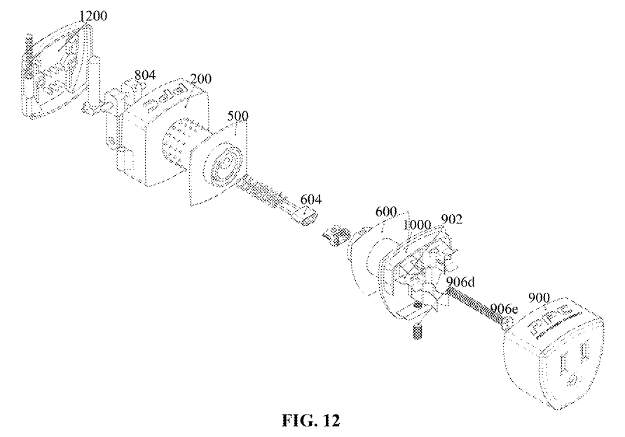

The sidewalls 800, 900 are preferably enclosed to prevent inadvertent access to the respective cavity (other than, e.g., with a male prong on the female side of the body 600). In preferred embodiments, one or both of the cavities formed with the bodies 200, 600 are configured to be encapsulated (principally by the sidewall, rear wall, and front wall). In one embodiment, best seen in FIG. 12, one or both of the bodies 200, 600 may include a selectively rotatable and lockable/closable cover 1200, via, e.g., a hinge member and a spring-loaded lock depressible by a user to open and close the cover 1200. The second housing body 600 preferably includes an outermost surface (preferably planar) that defines two or three recess formed thereon providing access to a two- or three-prong plug.

In one embodiment, the sidewall 900 of the second housing body 600 may be selectively removable from a base of the housing body 600 and fastened thereto with one or more screw/fasteners 906a-n, wherein “n” represents any number greater than one. The components of the second housing body 600 may be beneficially removed therefrom in order to fasten the shaft 500 to the second housing body 600. In one embodiment, shaft 500 includes an inner surface defining the channel 600 and an outer surface 1000 coupled to the door 102 defining the through hole 1102 (shown in FIG. 11) and that opposes the inner surface of the shaft 500, wherein the outer surface 1000 includes a threaded configuration thereon that is selectively removably coupled to the second housing body 104 (e.g., using a nut or other corresponding threaded configuration). In one embodiment, the threaded configuration is an over molded polymeric material directly coupled to the electrical wiring 604 to reduce the risk of electrical shock to a user.

In one embodiment, each of the housing bodies 200, 600 include a cap (i.e., a first cap 202, a second cap 204, and/or cover 1200) for selectively covering the access ports of the housing bodies 200, 600. In particular, the cap 202 may be selectively removably coupled to the first housing body 200 in a friction fit configuration, covering the first cavity 802, and including a tether member 204 coupling the cap 202 to the first housing body 200 when the cap is selectively removed from the first housing body 200. The cap 608 may be selectively removably coupled to the second housing body 600 in a friction fit configuration and covers the electrical socket port 806. The caps 202, 608 may be of an elastically deformable material and electrically insulating.

The electrically conductive male plug configuration 804 housed in the cavity 802 are preferably metallic prongs conducive to transferring current. In one embodiment, the prongs may be rotatable to a storage position enabling the cover 1200 to close on the sidewall encapsulating the prongs. When desired for use, the prongs may each be individually or collectively rotated by the user to an erect position for plugging into a conventional electrical outlet (e.g., formed on an extension cord) that may then be electrically coupled to a plug that can be plugged into a conventional 120/240 wall outlet. In one embodiment, the electrically conductive male plug configuration may be comprised of a USA standard two-prong plug, referred to as a Type A electrical outlet plug according to the U.S. Department of Commerce International Trade Administration (USDCITA), which is a standard power outlet plug in the United States of America, as is known generally in the art. In other embodiments, the prongs may be formed as a three-prong plug referred to as a Type B electrical outlet plug by the USDCITA, or other plugs configurations that may be standard in various different countries (e.g., Type C used commonly in Europe, Type D used commonly in India, Type E used commonly in France and other European countries, Type F used commonly in Russia, Types G through Type O, and the like. As discussed above, the prong configuration may be selectively determined by the user.

The second housing body 600 houses an electrically conductive female socket configuration 902, wherein the electrically conductive female socket configuration (e.g., formed with a plurality of substantially rigid metallic flexible metallic members 908a-n) is electrically coupled to the electrically conductive male plug configuration 802 in the first housing body 200. The first and second housing bodies 200, 600 are electrically coupled to one another in order to transfer electricity through the assembly 100 and door 102. The electrically conductive female socket configuration 902 may be comprised of one or more of a USA standard 3 prong outlet, standard USB port(s), etc. The electricity from a power source is configured to flow through the assembly 100 through, e.g., circuitry/wires/connectors. The assembly 100 may also utilize one or mor terminal springs that are utilized with the wiring to prevent, for example, the connectors from being inadvertently disconnected or damaged. To that end, the shaft 500 may include a channel for said wiring/connectors that is electrically connected to the male/female configurations. In another embodiment of the present invention, one or more AC-to-DC converters may be utilized to convert AC power to DC power, e.g., to power a USB port.

The shaft 500 may be composed of two ends (that may be the terminal ends) each respectively coupled to either the first or second housing bodies 200, 600, wherein the housings 200, 600, namely the rear surfaces 502, 606 thereon, are coupled thereto in a transversely overlapping configuration with respect to the shaft 500, i.e., the width of the housing bodies 200, 600 proximal to the end and adjacent to the door surfaces is greater than the width of the shaft proximal to the respective housing body.

In one embodiment, the rear surface 502 of the first housing sidewall 800 is directly coupled to the door rear surface 300 in a flush configuration when installed. Said another way, the rear surface 502, preferably defined by the perimeter edges of the first housing body 200, is parallel and no-coplanar with the door rear surface 300 to which it is coupled. To maintain the structural integrity and appearance of the door 102, an elastomeric material 700 (e.g., natural rubber) may be disposed on the rear surface 502 of the first housing body 200 and an elastomeric material 702 may be disposed on the rear surface 606 of the second housing body 606.

In one embodiment, the first housing body 200 and the second housing body 600 are coupled to one another through the shaft 500 in a longitudinally aligned and overlapping configuration to effectuate transfer of electricity. The first housing body 200 and the second housing body 104 are disposed proximal to a lower edge 400 of the door 102 to minimize any tripping hazards and for safety purposes. In one embodiment, the first housing body 200 is formed in a substantially perpendicular orientation relative to an orientation of the shaft 500 and including the first cavity 802 and the male electrically conductive plug configuration 804 configured to face in a direction substantially parallel to a plane defined by the door rear surface 300 (+/- °20, as illustrated in FIG. 7). This beneficially inhibits any tripping hazard by the user. Further, the first housing body 200 is operably configured to rotate relative to the shaft 500 to direct the attached cord(s), wherein the electrical connection internally may be through a constant electrically conductive contact, e.g., through a tongue-and-groove configuration.

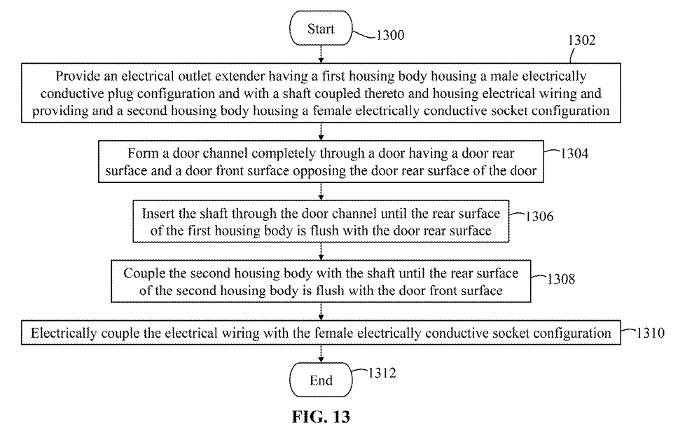

FIGS. 5-11 will be described in conjunction with the process flow chart of FIG. 13. Although FIG. 13 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 13 for the sake of brevity. In some embodiments, some or all of the process steps included in FIG. 13 can be combined into a single process. In particular, the method of installing the electrical outlet extender 100 on a door 102 starts at step 1300 and immediately proceeds to the step 1302 of providing a first housing body 200 with a rear surface 502, with a first housing sidewall 800 surrounding the rear surface 502 defining a first cavity 802 housing a male electrically conductive plug configuration 804 coupled to electrical wiring 604, and with a shaft 500 of a substantially rigid material coupled to the rear surface 502 of the first housing body 200, and defining a channel 600 with the electrical wiring disposed therein. The step 1302 also includes a second housing body 600 with a rear surface 606, with a second housing sidewall 900 surrounding the rear surface 606 of the second housing body 600, defining a second cavity 1100 housing an electrically conductive female socket configuration 902, and defining an electrical socket port 806 providing access to the electrically conductive female socket configuration 902.

Next, step 1304 includes forming a door channel 1102 (e.g., drilling) completely through a door 102 having a door rear surface 106 and a door front surface 106 opposing the door rear surface 106 of the door 102. Said another way, when desired for use, the user will either drill a hole into a door-like structure 102 that is configured to receive the shaft 500 or the user will use the conventionally formed hole in the door-like structure 102.

Next, step 1306 includes inserting the shaft 500 through the door channel 1102 until the rear surface 502 of the first housing body 200 is flush with the door rear surface 300. The shaft 500 may be formed with two pieces configured to be inserted into one another, e.g., in a telescopic coupling configuration (as seen in FIG. 12). If formed as two pieces, one portion of the shaft may be inserted into the hole and retained to the inside surface of the door 102 defining the hole with a plurality of sharp retaining members or spikes (approximately 2-10mm in length and approximately 0.1-5mm in diameter).

Next, step 1308 includes coupling the second housing body 600 with the shaft until the rear surface 606 of the second housing body 200 is flush with the door front surface 106. The inner surface of the first housing body may include an elastomeric gasket or foam material enabling deformation and protection of the housing bodies 200, 600 and door 102. Thereafter, step 1310 may include electrically coupling the electrical wiring with the electrically conductive female socket configuration 902 (to enable the configurations 804, 902 to be hot or live when an external electrical cord is coupled thereto). Said another way, the user may then connect the connectors to electrically connect the male/female configurations and insert another portion of the shaft 500 into first portion of the shaft 500 and connect the two using one or more fastener(s). The inner surface of the second housing body 600 may also include an elastomeric gasket or foam material enabling deformation and protection of the housing 600 and door 102, wherein the user may fasten the housing fastener until the gaskets slightly deform and/or there is an otherwise taut and/or compressed configuration relative to the door 102. The gaskets may substantially span the inner surfaces of the respective housing. The assembly may be disassembled in an opposite manner

In operation, another step may include inserting an electrical plug 704 of an extension cord 706 electrically charged from an electrical outlet 708 of a housing structure into the electrical socket port and electrically coupling the electrical plug 704 to the electrically conductive female socket configuration 902 and the male electrically conductive plug configuration 804. Caps 202, 608 and/or the cover 1200 may be selectively coupled thereto when the user does not desire to use the extender assembly 100. The process may terminate at step 1312.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. An electrical outlet extender for a door comprising:
a door operably coupled to a door frame, having a door front surface, a door rear surface opposing a front door surface, and a door thickness separating the door front and rear surfaces;
a first housing body with a rear surface coupled to the door rear surface and with a first housing sidewall surrounding the rear surface defining a first cavity housing a male electrically conductive plug configuration coupled to electrical wiring;
a shaft of a substantially rigid material coupled to the rear surface of the first housing body, defining a channel with the electrical wiring disposed therein, and interposed within a door and spanning the door thickness; and
a second housing body with a rear surface coupled to the shaft and the door front surface, with a second housing sidewall surrounding the rear surface of the second housing body, defining a second cavity housing an electrically conductive female socket configuration electrically coupled to the male electrically conductive plug configuration through the electrical wiring, and defining an electrical socket port providing access to the female electrically conductive socket configuration.

2. The electrical outlet extender for the door according to claim 1, wherein the rear surface of the first housing sidewall is directly coupled to the door rear surface in a flush configuration.

3. The electrical outlet extender for the door according to claim 2, further comprising:
an elastomeric material disposed on the rear surface of the first housing body; and
an elastomeric material disposed on the rear surface of the second housing body.

4. The electrical outlet extender for the door according to claim 1, wherein the shaft further comprises:
an inner surface defining the channel and an outer surface opposing the inner surface of the shaft and having a threaded configuration thereon and selectively removably coupled to the second housing body.

5. The electrical outlet extender for the door according to claim 4, wherein the threaded configuration is an over molded polymeric material directly coupled to the electrical wiring.

6. The electrical outlet extender for the door according to claim 1, further comprising:
a cap selectively removably coupled to the first housing body in a friction fit configuration, covering the first cavity, and including a tether member coupling the cap to the first housing body when the cap is selectively removed from the first housing body.

7. The electrical outlet extender for the door according to claim 1, further comprising:
a cap selectively removably coupled to the second housing body in a friction fit configuration, covering the electrical socket port.

8. The electrical outlet extender for the door according to claim 1, wherein the rear surface of the first housing body is coupled to the shaft in a transversely overlapping configuration and the rear surface of the second housing body is coupled to the shaft in a transversely overlapping configuration.

9. The electrical outlet extender for the door according to claim 1, wherein the first housing body and the second housing body are coupled to one another through the shaft in a longitudinally aligned and overlapping configuration.

10. The electrical outlet extender for the door according to claim 8, wherein the first housing body and the second housing body are disposed proximal to a lower edge of the door.

11. The electrical outlet extender for the door according to claim 1, wherein the first housing body is formed in a substantially perpendicular orientation relative to an orientation of the shaft and including the first cavity and the male electrically conductive plug configuration configured to face in a direction substantially parallel to a plane defined by the door rear surface.

12. The electrical outlet extender for the door according to claim 1, wherein the first housing body is operably configured to rotate relative to the shaft.

13. A method of installing an electrical outlet extender on a door comprising the steps of:
providing a first housing body with a rear surface, with a first housing sidewall surrounding the rear surface defining a first cavity housing a male electrically conductive plug configuration coupled to electrical wiring, and with a shaft of a substantially rigid material coupled to the rear surface of the first housing body, and defining a channel with the electrical wiring disposed therein and a second housing body with a rear surface, with a second housing sidewall surrounding the rear surface of the second housing body, defining a second cavity housing an electrically conductive female socket configuration, and defining an electrical socket port providing access to the electrically conductive female socket configuration;
forming a door channel completely through a door having a door rear surface and a door front surface opposing the door rear surface of the door;
inserting the shaft through the door channel until the rear surface of the first housing body is flush with the door rear surface;
coupling the second housing body with the shaft until the rear surface of the second housing body is flush with the door front surface; and
electrically coupling the electrical wiring with the electrically conductive female socket configuration.

14. The method according to claim 13, further comprising:
inserting an electrical plug of an extension cord electrically charged from an electrical outlet of a housing structure into the electrical socket port and electrically coupling the electrical plug to the electrically conductive female socket configuration and the male electrically conductive plug configuration.

15. The method according to claim 13, further comprising:
providing a first cap and a second cap;
coupling the first cap to the first housing body in a friction fit configuration and covering the first cavity; and
coupling the second cap to the second housing body in a friction fit configuration, covering the electrical socket port.
